(19) United States
(12) Patent Application Publication
(10) Pub. No.: US 2023/0090323 A1
(43) Pub. Date: Mar. 23, 2023

(54) OUTDOOR DISPLAY DEVICE FOR A STRING OF LIGHTS

(71) Applicant: Kircuit, Inc., Hockessin, DE (US)

(72) Inventor: Dubin Xu, Newark, DE (US)

(21) Appl. No.: 17/483,061

(22) Filed: Sep. 23, 2021

(51) Int. Cl. G09F 13/04

(52) U.S. Cl. CPC G09F 13/04

(57) ABSTRACT

A display unit has a base with a base plate, a set of reflectors and a transparent or translucent cover. The base plate has an array of openings. Each opening is sized to receive a light socket from a string of lights and hold the light socket. There is one reflector for each opening in the base plate positioned adjacent a respective opening in the base plate and against the front surface of the base plate. A transparent or translucent cover is positioned over the set of reflectors and connected to the base. Two or more display units can be connected together side by side, parallel or at an angle to one another to create displays having different heights, different widths, and different shapes. The user can easily create letters, numbers, symbols, icons or pictures through the choice and positioning of lights having different colors in the display units.

### FIELD OF INVENTION

The present invention relates generally to outdoor lighting displays.

### BACKGROUND OF THE INVENTION

There are a variety of illuminated signs and decorations that contain a set of light bulbs on a frame which are arranged and/or illuminated in a manner to convey information by displaying letters, numbers, symbols, icons or pictures. In nearly all of these displays the lights are permanently or semi-permanently attached to the frame and the lights cannot be easily changed.

U.S. Pat. No. 10,121,396 to Taylor et al., U.S. Pat. No. 8,824,125 to Cox et al., U.S. Pat. No. 6,314,669 to Tucker, United States Published Patent Application No. 2006/0075666 to Thielemans et al. and Korean Patent 101149059 disclose lighting displays in which modules containing LEDs are mounted within a frame. Russian Patent No. 138777 and U.S. Pat. No. 8,992,037 to Rycyna III disclose modules containing LEDs in which there is a flange above each LED or pixel that acts as a reflector. United States Published Patent Application No. 2008/0141571 of Kottwitz discloses a modular lighting display in which the modules are connected together side by side. In all of these displays the light panels containing LED lights are in a common plane. In these displays the information or object being displayed cannot be easily changed, except by changing the pattern in which the lights are illuminated.

There is a need for an outdoor lighting display in which the information to be displayed can be easily created and displayed information can be easily changed. There is also a need for an outdoor lighting display which has several modules that can be easily connected together and arranged in a manner such that the modules are not in a common plane.

### SUMMARY OF THE INVENTION

I provide a display unit for holding light bulbs in a string of lights that can be used alone or in combination with additional display units. The display units enable the user to create letters, numbers, symbols, icons or pictures through the choice and positioning of lights having different colors in the display unit. The display unit has a base that contains a base plate, a top, a first side, a second side and a bottom surrounding the base plate. The base plate has a front surface, a rear surface and an array of openings. Each opening is sized to receive a light bulb in a light socket from a string of lights and hold the light socket and light bulb. The top and the first side of the base have at least one projection. The second side and the bottom have at least one opening. The openings are sized and positioned to receive the projection or projections on the top and first side of a second display unit placed on or beside that display unit. There is at least one tab extending from each of the top, first side, second side and bottom. Each tab has a hole through the tab. Adjacent display units can be joined together with a bolt passing through the hole in a tab of each adjacent display unit.

The display unit has a set of reflectors, one for each opening in the base plate. Each reflector is positioned adjacent a respective opening in the base plate and against the front surface of the base plate. A transparent or translucent cover is positioned over the set of reflectors and connected to the base.

I further provide connection plates for connecting display units or modules containing two or more display units together to create a lighted display. The display units can be connected together side by side, parallel, at an angle to one another, or on top of one another to create displays having different heights, different widths, and different shapes.

The components of the display unit and the connection plates can be made of a suitable plastic to permit the display units to be used over a wide range of temperatures and weather conditions.

Other objects and advantages will become apparent from a description of certain present preferred embodiments of my display unit and displays containing those display units which are shown in the accompanying drawings.

### BRIEF DESCRIPTION OF THE DRAWINGS

FIG. 1 is a rear perspective view of a present preferred embodiment of my display unit for a string of lights.

FIG. 2 is a perspective view of the display unit for a string of lights shown in FIG. 1 with the light bulbs in light sockets of a string of lights positioned for insertion into the display unit.

FIG. 3 is a perspective view similar to FIG. 2 showing the light sockets containing the light bulbs in the display unit.

FIG. 4 is a perspective view similar to FIG. 3 showing the light sockets having been turned to secure the light sockets to the base plate of the display unit.

FIG. 5 is an exploded side view of the display unit and string of lights shown in FIG. 2.

FIG. 6 is a front perspective view of an outdoor lighting display having three display units connected together in a common plane.

FIG. 7 is a rear perspective view of the outdoor lighting display having three display units shown in FIG. 6.

FIG. 8 is a front view of a preferred connection plate.

FIG. 9 is a front perspective view of an outdoor lighting display having four display units connected together and a connection plate attached to the two bottom display units.

FIG. 10 is a perspective view of the embodiment shown in FIG. 9 having two additional connection plates.

FIG. 11 is a perspective view of an outdoor lighting display having eight display units connected together as two modules of four display units, the modules positioned at a right angle to one another by a connection plate.

FIG. 12 is a perspective view of an outdoor lighting display having eight display units connected together as two parallel modules of four display units and connection plates attached to and separating the modules.

FIG. 13 is a perspective view of an outdoor lighting display having eight display units connected together as four modules of two display units, the modules being connected by two connection plates to form a four-sided structure.

FIG. 14 is a perspective view of an outdoor lighting display having thirty two display units connected together as two modules of sixteen display units, the modules positioned to form an A-frame shape.

### DETAILED DESCRIPTION OF THE PREFERRED EMBODIMENTS

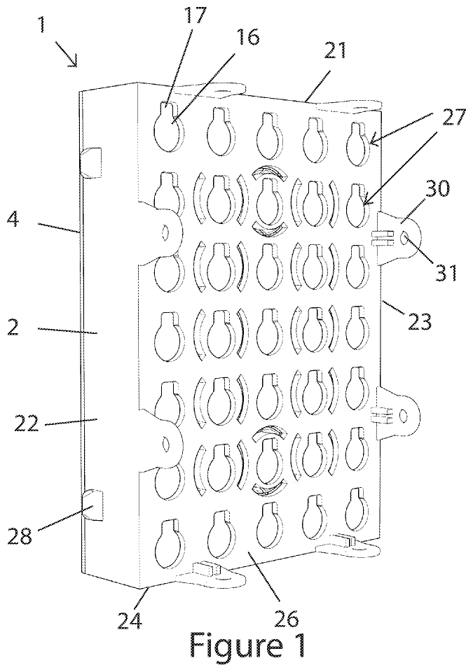

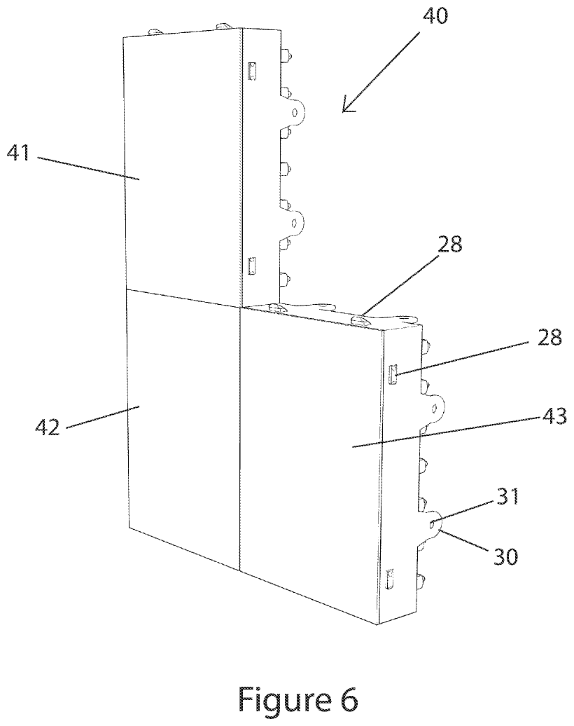

My outdoor lighting display has at least two display units of the type shown in FIGS. 1 through 5 which are connected together. The display units can be connected together in many different ways to create outdoor lighting displays of different shapes and sizes. FIGS. 6 through 14 show some of the possible outdoor lighting displays that can be made by connecting the display units together in different configurations.

Referring to FIGS. 1 through 5, my display unit 1 has a base 2, a set of reflectors 3 and a transparent or translucent cover 4. The base 2 is comprised of a base plate 20, a top 21, a first side 22, a second side 23 and a bottom 24 surrounding the base plate. The base plate has a front surface 25, a rear surface 26 and an array of openings 27. Each opening 6 is sized to receive a light bulb in a light socket from a string of lights and hold the light socket and light bulb.

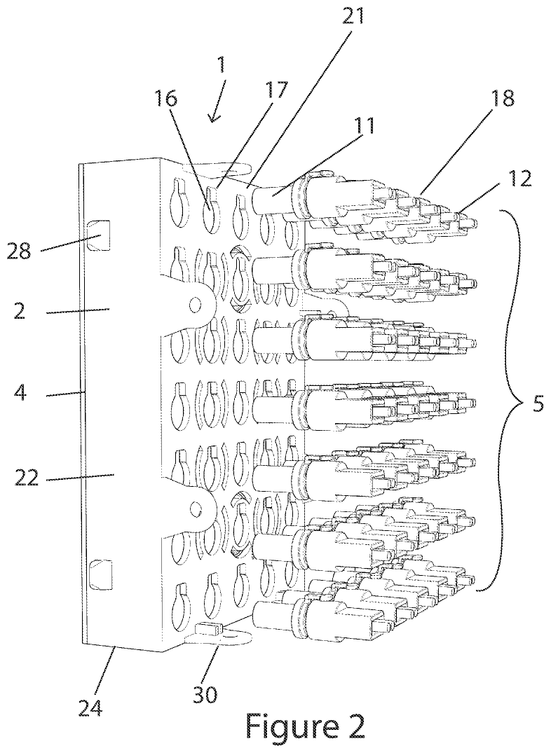

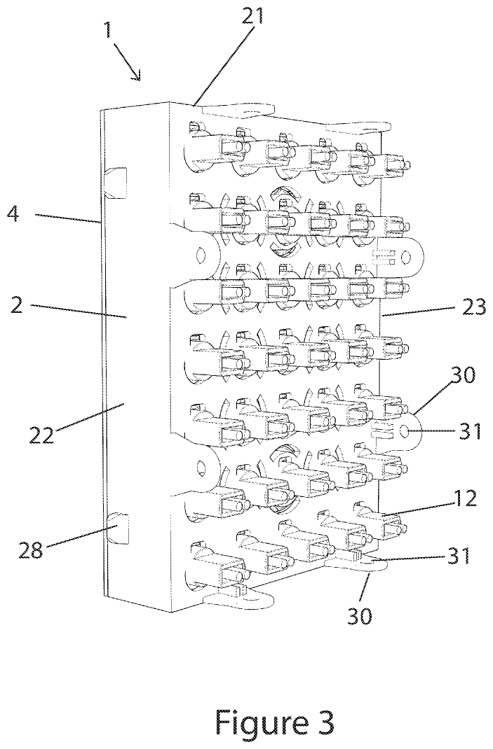

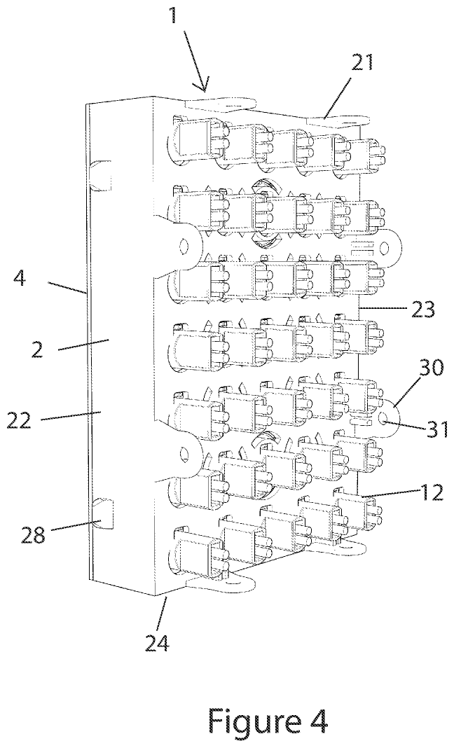

As can be seen in FIGS. 1 and 2 each opening consists of a circular hole 16 and a notch 17. The hole 16 is sized to receive an LED light bulb 11 and a portion of the light socket 12. The notch 17 is sized to receive the clip 18 on the light socket 12. The light socket 12 is inserted in a manner so that the LED light bulb has passed through the hole 16, the groove 19 in the light socket is aligned with the edge of the hole 16 and a portion of the clip 18 is in the notch 17. After the light bulbs have been inserted into their respective holes each light socket is rotated 90° compressing the clip 18 and locking the light socket containing the LED light in place. Each light socket can be rotated immediately after insertion. Alternatively one could wait until all of the sockets have been inserted as shown in FIG. 3 and then rotating the sockets to their locked positions shown in FIG. 4.

The display unit shown in FIGS. 1 through 5 has 35 openings in a 5×7 array. However, the display unit could be made in a larger size having more openings or a smaller size having fewer openings. Although the display unit shown in the drawings is rectangular, the display unit is not limited to that shape. For example, one could make the display unit as a hexagon or octagon or other shapes.

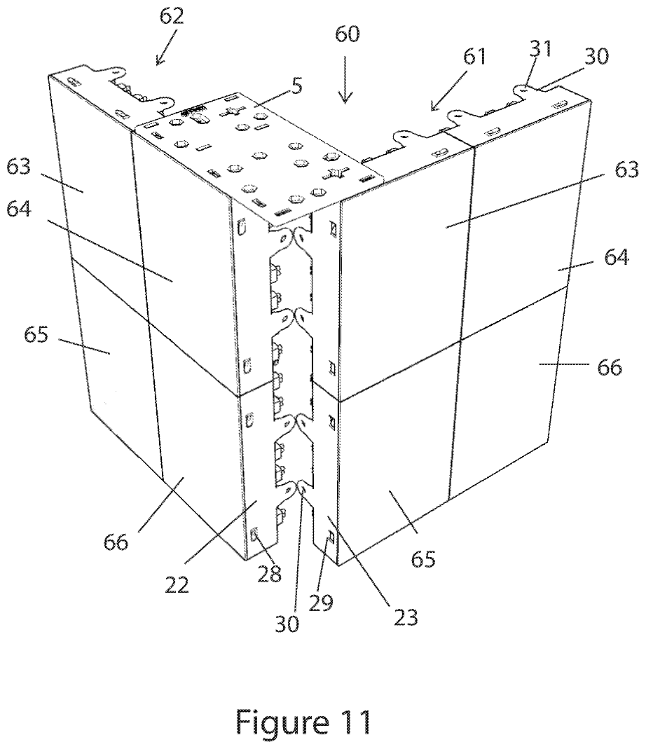

The top 21 and the first side 22 of the base 2 have a pair of projections or hooks 28. The second side 23 and the bottom 24 of the base 2 have pair of holes 29 (See FIG. 11). The projections or hooks 28 and the holes 29 are sized and positioned so that when a first display unit is placed on or beside a second display unit the projections or hooks 28 from the second display unit will fit into the holes 29 of the first display unit to properly align the two units and connect them together.

I prefer to provide a pair of tabs 30 that extend rearward from each of the top 21, first side 22, second side 23 and a bottom 24 of the base 2. There is a hole 31 through each tab. When a first display unit is placed on or beside a second display unit tabs from the second display unit may be aligned with tabs first display unit. Then one could attach the two units together using a bolt and nut, the bolt passing through the holes in the aligned tabs. These tabs can also be used to attach a connection plate the display unit. FIGS. 11, 12, 13 and 14 show outdoor lighting displays containing display units connected together by a connection plate or connection plates. Use of connection plates can assure that the connected display units will not move relative to one another.

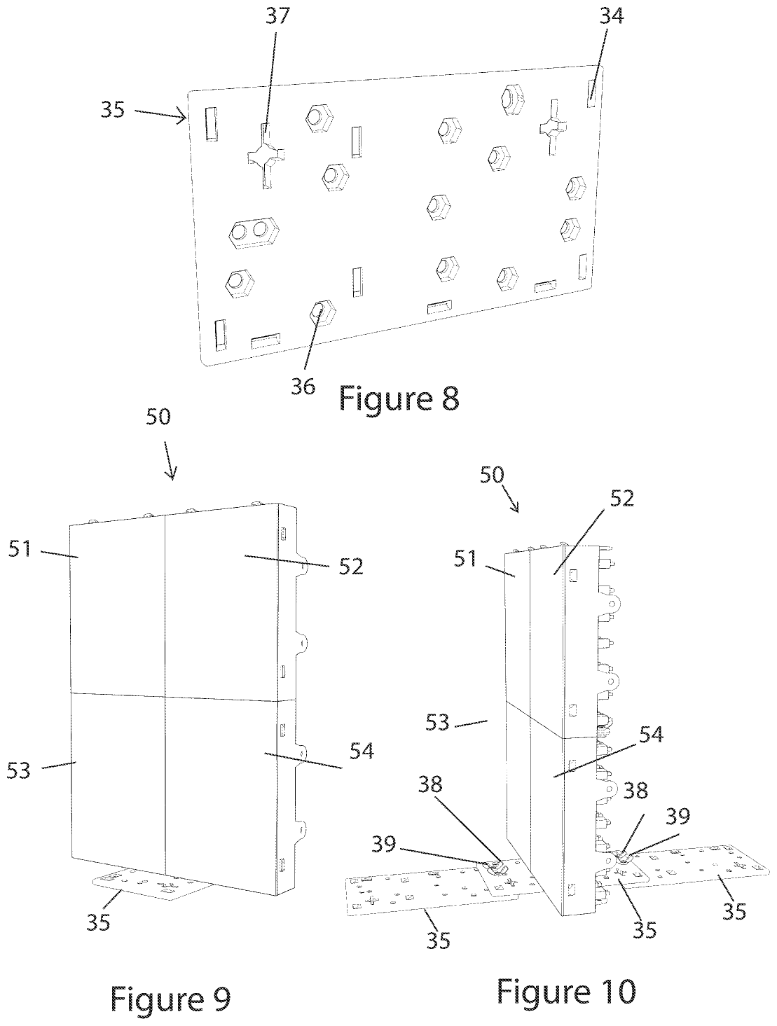

A preferred connection plate is shown in FIG. 8. This connection plate 35 has openings 34 sized to receive the projection on the top and on the first side of a display unit. The connection plate also has a total of fourteen holes 36 for a bolt. I prefer to use bolts 38 having a hexagon shaped head and wing nuts 39 to attach connection plates to one another, which can be seen in FIG. 10, to attached a connection plate to a display unit, and to join two adjacent display units together. A hexagon shaped recess is provided for twelve of the holes 36 in the connection plate 5 to receive the hexagon head of the bolt and prevent the bolt from rotating. Providing wing nuts for these bolts allows the user to attach the connection plate to a display unit by hand without using a wrench. The connection plate also has two X-shaped holes 37 that can each receive a ground spike. Ground spikes may be used to secure the display as shown in FIGS. 10 and 11.

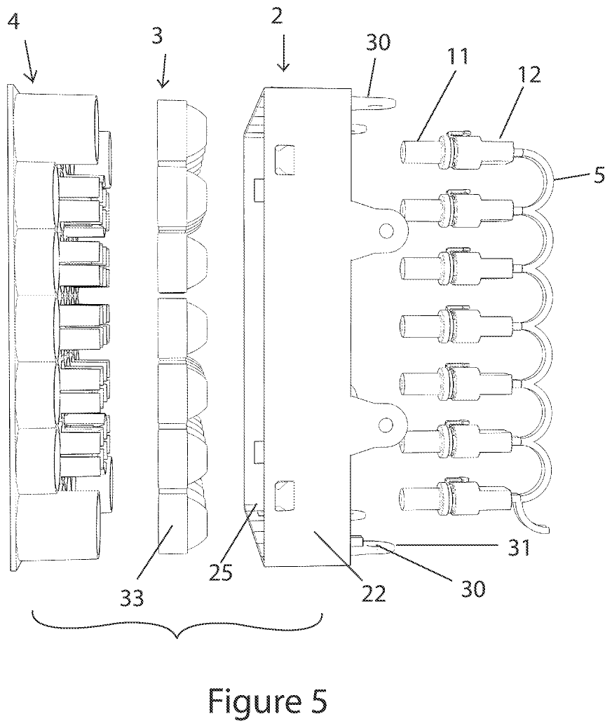

As can be seen most clearly in FIG. 5 there are a set of reflectors 3 in the display unit 1, one reflector 33 for each opening in the base plate 20. Each reflector 33 is positioned adjacent a respective opening 6 in the base plate 20 against the front surface of the base plate. The reflectors may be connected to one another such that the set of reflectors constitute a single structure. The reflectors may be metal. However I prefer to use reflectors made of plastic that have been coated with a reflective material. A copolymer of acrylonitrile, butadiene and styrene called ABS is a suitable plastic. The base 2 may also be made of ABS or polyvinyl chloride. I prefer that the base be black in color.

A cover 3 made of a light transmissive material fits over the set of reflectors and is connected to the base 2. The cover can be made of polycarbonate and preferably is transparent.

I prefer to use of strings of lights in which the LUX (unit of illuminance, lumens/m2) percentage is: Red 25.87% Green 33.44% Yellow 30.40% Blue 27.74% Cyan 25.3% Purple 40.21% and White 30.5%. When these light strings are used in a display unit having a transparent polycarbonate cover, plated ABS reflectors and a black ABS base, the lighted display is clearly viewable on a sunny day.

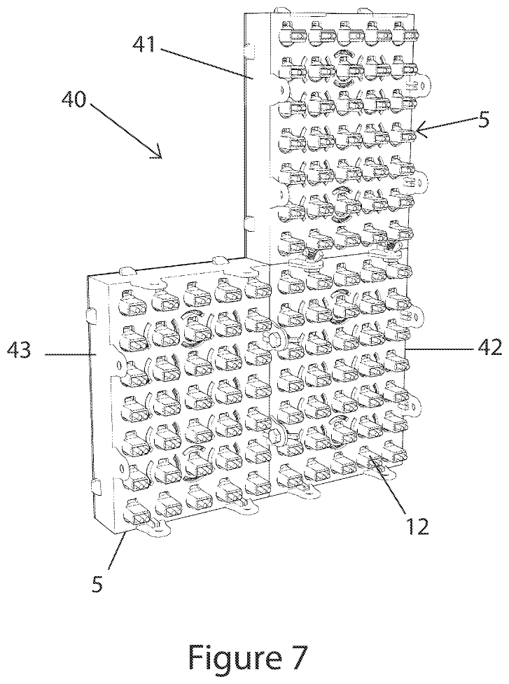

A first preferred outdoor lighting display 40 is shown in FIGS. 6 and 7. In this display 40 one display unit 41 is on top of a second display unit 42 and a third display 43 unit is beside the second display unit. The display units are positioned so that the projections on the top of the second display unit 42 are in holes in the bottom of the first display unit 41 and the projections on the first side of the third unit 43 are in the holes in the second side of the second unit 42. There is a string of lights 5 in each of the display units 41, 42, 43.

A second preferred outdoor lighting display 50, shown in FIGS. 9 and 10, has four display units 51, 52, 53 and 54, one unit in each quadrant. In this display 50 the first display unit 51 is beside the second display unit 52 and on top of the third display unit 53. The fourth display unit 54 is below the second display unit 52 and beside the third display unit 53. There is a string of lights 5 in each display unit. FIG. 9 shows one connection plate 5 attached to the bottom of the third display unit 53 and to the bottom of the fourth display unit 54. The connection plate acts as a foot supporting the display 50. One connection plate can be used for soft terrains such as dirt or grass, where a spike can be stuck into the ground to secure the display. FIG. 10 shows three connection plates being used for the foot. Bolts 38 and wing nuts 39 connect one connection plate to either end of the connection plate that is attached to display units 53 and 54. This longer foot is better suited for usage on hard surfaces such as concrete. Additional connection plates can be used to improve stabilization.

Referring to FIG. 11 a third preferred outdoor lighting display 60 has a first module 61 positioned at a right angle to a second module 62. The modules are tied to each other by a connection plate 5. Each module has four display units 63, 64, 65, 66 connected together in the same manner as the four display units 51, 52, 53, 54 shown in FIGS. 9 and 10.

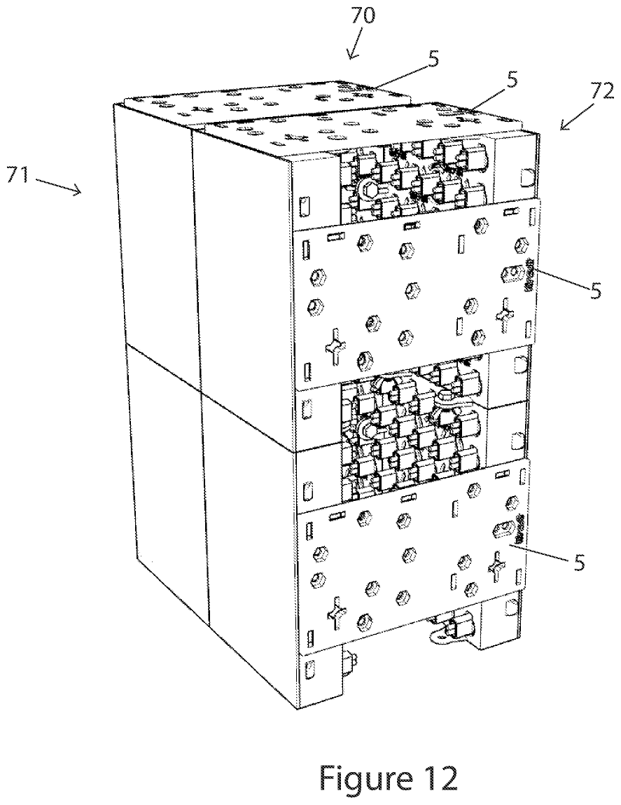

FIG. 12 shows a fourth preferred outdoor lighting display consisting of two modules 71, 72, each containing four display units. The modules 71, 72 are back to back and parallel to one another. The modules are held in place by connection plates 5 between the top and outer sides of the upper display units in each module and a connection plate 5 between the outer sides of opposite lower display units. The display units in each module are connected together in the same manner as the four display units 51, 52, 53, 54 shown in FIGS. 9 and 10.

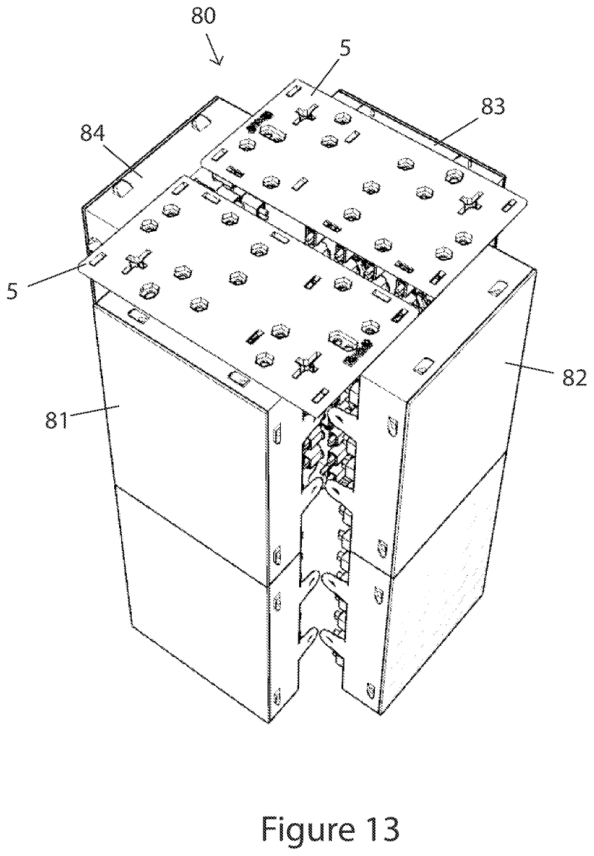

A fifth preferred outdoor lighting display 80 shown in FIG. 13 has four modules 81, 82, 83, 84, each module containing four display units. The display units in each module are connected together in the same manner as the four display units 51, 52, 53, 54 shown in FIGS. 9 and 10. The modules 81, 82, 83, 84 are held together by two connection plates 5, secured to the top of the upper display units in each module to form a four sided structure. Each side of the display 80 can be illuminated.

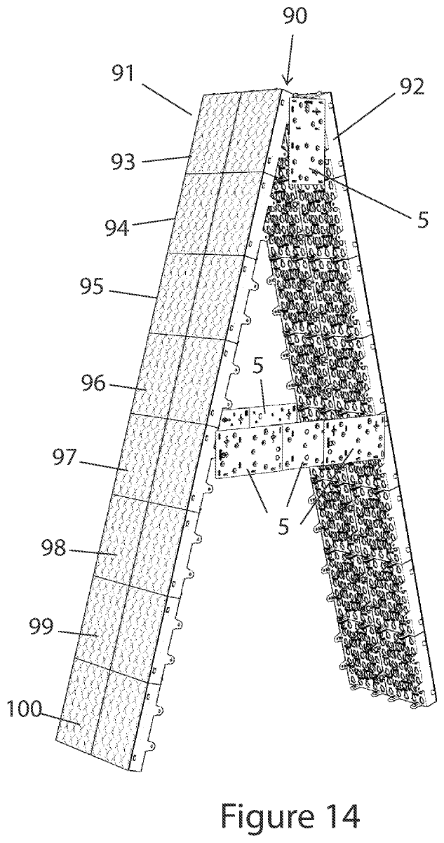

A sixth preferred outdoor lighting display 90 shown in FIG. 14 has two modules 91, 92. Each module contains eight display units. In each module side by side pairs of display units 93, 94, 95, 96, 97, 98, 99, 100 are arranged one pair after another. The projections on the top of each display unit are in an opening in the bottom of the display unit resting upon that display unit. In each pair of side by side display units each of the projections on the first side of one unit is in a corresponding opening in the second side of the other display unit. Connection plates 5 are attached between the two modules to create an A-frame display.

Using strings of LED lights as the light source for the displays enables the user to create a display containing lights that all have the same color, or lights having different colors. The user can create letters, numbers, symbols, icons or pictures through the choice and positioning of lights having different colors in the display units. The user can also change the display by rearranging the lights or replacing lights in the light string. It is also possible to create letters, numbers, symbols, icons or pictures by providing illuminated lights in some, but not all, of the openings in the base plate of one or more display units in a display.

Providing display units that contain a string of LED lights and making the display units so that they can be easily and securely connected to one another allows the user to create displays of different heights and lengths. The displays could be used for commercial purposes, such as advertising, or residential decorations, such as a holiday display. Displays that are easily seen in daylight as well as during the night can be created.

All of the components of the display unit as well as the connection plate can be made of durable plastic materials so that the display units, as well as the display containing those units, will not be damaged by rain or snow. While the display unit is designed for outdoor use, display units could be used indoors.

The display unit disclosed here enables the user to create an affordable outdoor LED pixel lights board or information display board for both commercial use and residential use. The user can easily change the colors in a display and may assemble display units to create display screens of different sizes and shapes that maximize the creativity and usage scenario when anyone uses this product.

Although I have described and shown certain present preferred embodiments of my display unit and lighting displays that can be created with my display units my invention is not limited thereto but may be variously embodied within the scope of the following claims.

I claim:

1. A display unit for holding light bulbs in a string of lights comprising:
a base comprised of a base plate, a top, a first side, a second side and a bottom surrounding the base plate, the base plate having a front surface, a rear surface and an array of openings, each opening sized to receive a light bulb in a light socket from a string of lights and hold the light socket and light bulb, the top and the first side having at least one projection, the second side and the bottom having at least one opening, and at least one tab extending from each of the top, first side, second side and bottom, each tab having a hole through the tab;
a set of reflectors, one for each opening in the base plate, each reflector positioned adjacent a respective opening in the base plate, the set of reflectors being adjacent the front surface of the base plate; and
a cover positioned over the set of reflectors and connected to the base, the cover made of a material that allows light to pass through the cover.

2. The display unit of claim 1 wherein the base, set of reflectors and cover are plastic.

3. The display unit of claim 2 wherein the plastic is selected from the group consisting of ABS, polycarbonate and polyvinyl chloride.

4. The display unit of claim 1 also comprising at least one connection plate connected to the top, first side, second side or the bottom of the base.

5. The display unit of claim 4 wherein the connection plate is attached to the bottom and extends away from the front cover in one direction and extends away from the base in an opposite direction.

6. The display unit of claim 1 also comprising a string of lights having a plurality of light sockets each containing a light bulb, at least one light socket being within a hole in the base plate.

7. The display unit of claim 6 wherein the light bulb is an LED light bulb.

8. A system for displaying light from light bulbs in at least one string of lights comprising:
a plurality of display units each display unit comprised of:
a base comprised of a base plate, a top, a first side, a second side and a bottom surrounding the base plate, the base plate having a front surface, a rear surface and an array of openings, each opening sized to receive a light bulb in a light socket from a string of lights and hold the light socket and light bulb, the top and the first side having at least one projection, the second side and the bottom having at least one opening, and at least one tab extending from each of the top, first side, second side and bottom, each tab having a hole through the tab, wherein the at least one opening in the bottom is sized and positioned to receive the at least one projection on the top of a second display unit and wherein the at least one opening in the second side is sized and positioned to receive the at least one projection on the first side of a second display unit;
a set of reflectors, one for each opening in the base plate, each reflector positioned adjacent a respective opening in the base plate, the set of reflectors being adjacent the front surface of the base plate; and
a cover positioned over the set of reflectors and connected to the base, the cover made of a material that allows light to pass through the cover; and
at least one connection plate connected to at least one display unit.

9. The system of claim 8 wherein the at least one connection plate connects two display units together.

10. The system of claim 8 wherein the at least one connection plate is attached to the bottom of at least one display unit.

11. The system of claim 8 also comprising at least one string of lights in the display unit.

12. The system of claim 10 wherein the string of lights contains LED light bulbs.
